(19) United States
(12) Patent Application Publication
(10) Pub. No.: US 2007/0092972 A1
(43) Pub. Date: Apr. 26, 2007

(54) Self-contained phosphate sensors and method for using same

(75) Inventors: Caibin Xiao, Harleysville, PA (US); Timothy Mark Sivavec, Clifton Park, NY (US); David Birenbaum Engel, The Woodlands, TX (US); Andrew Michael Leach, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/259,712

(22) Filed: Oct. 26, 2005

(51) Int. Cl. G01N 31/22

(52) U.S. Cl. 436/103; 422/56

(57) ABSTRACT

Embodiments of the invention provide self-contained phosphate sensors with an analyte-specific reagent and a pH-modifier. The analyte-specific reagent includes a molybdenum salt or metal complex and a dye. The self-contained phosphate sensors can be used either in aqueous or non-aqueous solution or as a solid-state device. These self-contained phosphate sensors require no post-addition reagents to determine phosphate concentrations and the phosphate determination test requires a reduced number of procedural steps. Moreover, the self-contained phosphate sensor provides enhanced sensitivity and faster response time. Embodiments of the invention also provide a method for determining phosphate concentrations in a sample. The phosphate concentration in a sample can be quantified using a calibration curve generated by testing samples with known phosphate concentrations.

### BACKGROUND

Embodiments of the invention relate to self-contained phosphate sensors in solution or within a film. The invention also includes embodiments that relate to methods of determining phosphate concentration in a test sample using self-contained phosphate sensors.

Phosphate is a frequently analyzed substance in the water treatment industry. Phosphate analysis is also common in environmental monitoring, in clinic diagnosis, and in other industrial places such as mining and metallurgical processes. Optical sensors are commonly used for analysis of phosphate.

A commonly used optical method for phosphate determination is the molybdenum blue method. The basic mechanism of the molybdenum blue method includes the formation of a heteropoly acid (HPA) by reaction of an orthophosphate with a molybdate. A molybdic acid is formed and then reduced using a reducing agent under acidic conditions resulting in color generation. Several other methods for phosphate analysis in aqueous solution based on the HPA chemistry are also known. They include vanadomolybdophosphoric acid method, molybdenum-stannous chloride method, and cationic dye-HPA complex method. The HPA method may be calorimetric, that is a color change of the sensor results after contacting with the analyte, and/or it may be photometric, that is a measurable change in the optical property of the sensor results after contacting with the analyte.

The known photometric methods for phosphate analysis based on the formation of HPA require a strong acidic media, necessitating the use of concentrated sulfuric acid solutions in sensor formulations. In the case of cationic dye-HPA complex method, triphenylmethane dyes are commonly used. The absorption band of triphenylmethane solutions at a neutral pH usually overlaps with that of the dye-HPA complex. Thus, the pH of the test media for phosphate determination has to be controlled below the transition pH of the dye in order to reveal the absorbance change due to formation of the dye-HPA complex. The known photometric methods have several disadvantages, including requiring corrosive and toxic reagents and, in the case of cationic dye-HPA complex, being highly pH dependent.

Silicate interference is another disadvantage of the HPA methods for phosphate analysis. A 3.0 ppm silicate in the sample water is known to interfere with cationic dye-HPA method. The commonly used molybdenum blue method is known to tolerate up to only 10 ppm silicate concentrations. Silicates are ubiquitous in natural water and hence it becomes difficult to determine low concentrations of phosphate in these cases because of the silicate interference.

Moreover, the reagents employed in known photometric methods are usually incompatible, leading to a stepwise approach to phosphate determination. The sample is added to a reactor (or confined location) with pre-existing reagents and then exposed to the separately stored reducing agent. This instability and lack of chemical compatibility of the reagents hinders a one-reactor approach, thus restricting the development of self-contained phosphate sensors.

For convenient and efficient application of phosphate sensors as on-site test devices, self-contained solid sensors are needed. Because optical indicators were originally developed for aqueous applications, their immobilization into a solid support is a key issue for their application in optical sensing. The incompatibility of reagents and the low pH requirement hinders this immobilization. Additionally, the sensitivity of the solid-state phosphate sensors to low phosphate concentrations is also an issue. For example, in U.S. Pat. No. 5,858,797, a phosphate test strip based on molybdenum blue chemistry was described to be sensitive to phosphate concentration only above 6 ppm. Moreover, the molybdenum blue reagent and the reducing agent had to be deposited into separate layers to minimize reagent stability problems.

Therefore, there is a need for self-contained phosphate sensors that can be utilized in solution as well as in solid-state. Moreover, it is desirable that the phosphate sensors do not require corrosive reagents and are sensitive to low concentrations of phosphate.

### BRIEF DESCRIPTION OF THE DRAWINGS

FIG. 1 is a cross-section of a self-contained phosphate sensor disposed as a film on a substrate constructed in accordance with an embodiment of the invention.

FIG. 2 is a cross-section of the self-contained phosphate sensor of FIG. 1 in contact with a phosphate test sample.

FIG. 3 is a cross-section of the self-contained phosphate sensor of FIG. 1 after contacting with the phosphate-test sample resulting in a change in the optical property of the phosphate sensor.

FIG. 4 is a set of spectra at different phosphate concentrations for the self-contained phosphate sensor of FIG. 1 comprising h-PBMP-Zn-PCViolet Complex in Dowanol.

FIG. 5 is a set of spectra at different phosphate concentrations for the self-contained phosphate sensor of FIG. 1 comprising h-PBMP-Zn-PCViolet Complex in polymer matrix.

FIG. 6 is a calibration curve for the self-contained phosphate sensor of FIG. 1 comprising h-PBMP-Zn-PCViolet Complex in Dowanol, obtained by plotting absorbances at 650 nm as a function of phosphate concentration.

FIG. 7 is a set of spectra at different phosphate concentrations for the self-contained phosphate sensor of FIG. 1 comprising Azure C and molybdate salt in water.

FIG. 8 is a calibration curve for the self-contained phosphate sensor of FIG. 1 comprising Azure C and molybdate salt in water, obtained by plotting absorbances at 650 nm as a function of phosphate concentration.

FIG. 9 is a set of spectra at different phosphate concentrations for the self-contained phosphate sensor of FIG. 1 comprising Azure B and molybdate salt in water.

FIG. 10 is a calibration curve for the self-contained phosphate sensor of FIG. 1 comprising Azure B and molybdate salt in water showing blue-to-violet reaction, obtained by plotting absorbances at 650 nm as a function of phosphate concentration.

FIG. 11 is a calibration curve for the self-contained phosphate sensor of FIG. 1 comprising Brilliant Cresyl Blue and molybdate salt in water, obtained by plotting absorbances at 622 nm as a function of phosphate concentration.

FIG. 12 is a low-concentration calibration curve for the self-contained phosphate sensor of FIG. 1 comprising Azure B and molybdate salt in water, obtained by plotting absorbances at 650 nm as a function of phosphate concentration.

FIG. 13 is a set of spectra at different phosphate concentrations for the self-contained phosphate sensor of FIG. 1 comprising Azure B and molybdate salt in polymer matrix.

FIG. 14 is a calibration curve for the self-contained phosphate sensor of FIG. 1 comprising Azure B and molybdate salt in polymer matrix, obtained by plotting absorbances at 650 nm as a function of phosphate concentration.

FIG. 15 is a set of spectra at different phosphate concentrations for the self-contained phosphate sensor of FIG. 1 comprising Malachite Green and molybdate salt in polymer matrix.

FIG. 16 is a calibration curve for the self-contained phosphate sensor of FIG. 1 comprising Malachite Green and molybdate salt in polymer matrix, obtained by plotting absorbances at 650 nm as a function of phosphate concentration.

FIG. 17 is a set of spectra at different phosphate concentrations for the self-contained phosphate sensor of FIG. 1 comprising Basic Blue and molybdate salt in polymer matrix.

FIG. 18 is a calibration curve for the self-contained phosphate sensor of FIG. 1 comprising Basic Blue and molybdate salt in polymer matrix, obtained by plotting absorbances at 650 nm as a function of phosphate concentration.

FIG. 19 is a set of spectra at different phosphate concentrations for the self-contained phosphate sensor of FIG. 1 comprising Methylene Blue and molybdate salt in polymer matrix.

FIG. 20 is a calibration curve for the self-contained phosphate sensor of FIG. 1 comprising Methylene Blue and molybdate salt in polymer matrix, obtained by plotting absorbances at 650 nm as a function of phosphate concentration.

FIG. 21 is a set of spectra at different phosphate concentrations for the self-contained phosphate sensor of FIG. 1 comprising Basic Blue and molybdate salt in a plasticized polymer matrix.

FIG. 22 is a calibration curve for the self-contained phosphate sensor of FIG. 1 comprising Basic Blue and molybdate salt in a plasticized polymer matrix, obtained by plotting absorbances at 650 nm as a function of phosphate concentration.

### SUMMARY

According to one embodiment of the invention, a self-contained phosphate sensor is described. The self-contained phosphate sensor includes at least one analyte-specific reagent and at least one pH-modifier. The self-contained phosphate sensor may be used in solution or as a solid-state device. The method of determining phosphate concentration in a test sample using the self-contained phosphate is also described.

According to one aspect, the analyte-specific reagent includes a molybdate salt and a dye and a sulfonic acid as the pH-modifier. The self-contained phosphate sensor may further include a solvent or may be immobilized in a polymer matrix.

According to another aspect, the analyte-specific reagent includes a metal complex and a dye and a sulfonic acid as the pH-modifier. The self-contained phosphate sensor may also include a non-aqueous solvent. According to a further aspect, the analyte-specific reagent includes a metal complex and a dye and an amine as the pH-modifier. The self-contained phosphate sensor may be immobilized in a polymer matrix.

According to an embodiment of the invention, a method of determining phosphate in a test sample is described. The method includes, contacting a test sample with a self-contained phosphate-sensor described above, measuring a change in an optical property of the self-contained phosphate sensor produced by contacting the test sample with the self-contained phosphate-sensor, and converting the change in optical property to the phosphate concentration.

### DETAILED DESCRIPTION OF PREFERRED EMBODIMENTS

In the following specification and the claims which follow, the singular forms “a”, “an” and “the” include plural referents unless the context clearly dictates otherwise.

Embodiments of the self-contained phosphate sensors described herein can be used either in aqueous or non-aqueous solution or as a solid-state device. Such self-contained phosphate sensors have the advantage that no post-addition reagents are required to determine phosphate concentrations and the phosphate determination test requires a minimal number of procedural steps. Moreover, self-contained phosphate sensors provide enhanced sensitivity and a faster response time. Embodiments of the invention also provide a method for determining phosphate concentrations in a test sample. The phosphate concentration in a test sample can be quantified using a calibration curve generated by testing samples with known phosphate concentrations.

In one aspect, the self-contained phosphate sensor is an optical sensor. Optical sensors possess a number of advantages over other sensor types, the most important being their wide range of transduction principles: optical sensors can respond to analytes for which other sensors are not available. Also, with optical sensors it is possible to perform not only “direct” analyte detection, in which the spectroscopic features of the analyte are measured, but also “indirect” analyte detection, in which a sensing reagent is employed. Upon interaction with the analyte species, such a reagent undergoes a change in its optical property, e.g. elastic or inelastic scattering, absorption, luminescence intensity, luminescence lifetime or polarization state. Significantly, this sort of indirect detection combines chemical selectivity with that offered by the spectroscopic measurement and can often overcome otherwise troublesome interference effects.

The above-mentioned self-contained phosphate sensors include an analyte-specific reagent and a pH-modifier. As used herein, “analyte-specific reagents” are compounds that exhibit change in colorimetric, photorefractive, photochromic, thermochromic, fluorescent, elastic scattering, inelastic scattering, polarization, and any other optical property useful for detecting physical, chemical and biological species. Analyte-specific reagents may include metal complexes or salts, organic and inorganic dyes or pigments, nanocrystals, nanoparticles, quantum dots, organic fluorophores, inorganic fluorophores, and their combinations thereof.

pH-Modifiers in the phosphate sensors serve as buffers and maintain the pH level of the sensor formulations at a constant pH which is preferable for the sensing mechanism. The choice of pH-modifiers depends upon the nature of the analyte-specific reagent used, but pH-modifiers may include acids, bases, or salts.

In one aspect, the self-contained phosphate sensor includes a molybdate salt and a dye as the analyte-specific reagent and a sulfonic acid as the pH-modifier. The molybdate salt may be any of the various soluble salts commercially available and compatible with the other constituents. Examples of suitable molybdate salts that may be used include, but are not limited, to ammonium, sodium, potassium, calcium and lithium molybdates. In another aspect, ammonium heptamolybdate is used as a molybdate salt.

The dye is a chromogenic indicator, which shows a change in the optical property of the sensor, after contacting the dye with the molybdate salt and the phosphate. Some examples of suitable dyes that may be employed in the analyte-specific reagents include azo dyes, oxazine dyes, thiazine dyes, triphenylmethane dyes, and any combinations thereof. In one aspect, the analyte-specific reagent includes thiazine or oxazine dyes. Some specific examples of thiazine and oxazine dyes that may be used include, but are not limited to, Azure A, Azure B, Basic Blue, Methylene Blue, and Brilliant Cresyl Blue.

Thiazine and oxazine dyes are used because the main absorption band in the spectra of most thiazine and oxazine dyes in the range of 400 nm to 800 nm does not undergo any significant change when the test solution pH is adjusted from 3 to 0.5. This is in contrast to the triphenylmethane dye known in the art for phosphate analysis. The aqueous solutions of the triphenylmethane dyes undergo a color transition in the pH range of 0 to 2, exhibiting an intense color with an absorption maximum ranged from 550 nm to 650 nm at neutral pH and much less color or colorless at low pH. Because the absorption band of the triphenylmethane dye solution at neutral pH usually overlaps with that of the dye-HPA complex, pH of the test media for phosphate determination must be controlled below the transition pH of the dye in order to reveal the absorbance change due to formation of the dye-HPA complex. Thus strong acids are required with triphenylmethane dyes and molybdate salts. Thiazine and oxazine dyes on the other hand do not require very strong acidic conditions to suppress dye color. In fact, low concentrations of low-acidity pH-modifiers are able to bring about the color change in this case.

As noted, a sulfonic acid may be used as a pH-modifier in the self-contained phosphate sensor described herein. Suitable sulfonic acids are selected such that the pH of the sensor formulation is in the range from about 0.5 to 3. In one aspect para-toluenesulfonic acid is used as a pH-modifier. The concentration of the sulfonic acid is selected such that the color transition of the dye occurs, or a change in absorbance occurs, on contacting with the molybdate salt and the phosphate.

For example, when the thiazine and oxazine dyes are mixed with molybdate in an aqueous solution in which the hydrogen ion to molybdate concentration ratio is less than 30, a significant red shift of the main absorption band of the dyes is observed. Upon addition of phosphate to the solution, the solution turns blue. On the other hand, when the thiazine or oxazine dye is mixed with molybdate in an aqueous solution in which the hydrogen ion to molybdate concentration ratio is kept in the range between 30 and 120, the main absorption band of the dye remains the same and no red shift is observed. In this case, the main absorption band decreases upon addition of phosphate to the test solution. The decrease in absorbance is proportional to the phosphate concentration.

In one aspect, the ratio of the hydrogen ion concentration to molybdate concentration is in the range from about 0.1 to about 150, while in another aspect, the ratio of the hydrogen ion concentration to molybdate concentration is in the range from about 1 to about 120, and in a further aspect, the ratio of the hydrogen ion concentration to molybdate concentration is in the range from about 30 to about 120.

In a further aspect, the self-contained phosphate sensor described herein, includes at least one additive from the group of polyethylene glycols, polypropylene glycols, polyoxyethylene alkyl ethers, polyvinyl alcohols, or any combinations thereof. The above additives facilitate the solubilization of the analyte-specific reagents and the dyes and also deter the formation of phosphomolybdate-dye aggregates. Thus, by addition of the above additives, precipitation of the phosphomolybdate-dye species resulting in signal loss may be prevented. Additionally, when the self-contained phosphate sensors are immobilized in a polymer matrix, the above compounds may function as plasticizers and may aid in enhancing the permeability of the polymer matrix to the analyte species (phosphate in this case).

In one aspect, polyethylene glycol is used as an additive to the self-contained phosphate sensor. In one aspect, molecular weight of the polyethylene glycol additive is in the range from about 100 g/mol to about 10,000 g/mol, while in another aspect, molecular weight of the polyethylene glycol is in the range from about 200 g/mol to about 4000 g/mol, and in a further aspect, molecular weight of the polyethylene glycol is in the range from about 400 g/mol to about 600 g/mol. In one aspect, the weight fraction of the polyethylene glycol additive to the sensor formulation is in the range from about 0.1 wt % to about 20 wt %, while in another aspect, the weight fraction of the polyethylene glycol additive to the sensor formulation is in the range from about 0.5 wt % to about 10 wt %, and in a further aspect, the weight fraction of the polyethylene glycol additive to the sensor formulation is in the range from about 1 wt % to about 5 wt %.

In a further aspect, the self-contained phosphate sensor described herein includes a signal enhancer. The signal enhancer may be formed of the same material as the pH-modifier or may be formed of a different material. Signal enhancers may be used to mask free isopolymolybdates that are to be distinguished from phosphomolybdate species. If not masked, the free isopolymolydbates may ion pair with the dyes resulting in a higher background signal or reduced signal due to phosphate alone. Examples of a suitable signal enhancer include, but are not limited to, oxalic acids, sulfonic acids, oxalates, sulfonates, and any combinations thereof.

In one aspect, the analyte-specific reagent includes a metal complex and a dye. The metal complex is selected such that it has high specificity to the analyte (phosphate in this case). Examples of suitable metal complexes that can be used include zinc complexes and cobalt complexes. The above metal complex further includes at least one ligand capable of coordinating with the metal cation. The metal ligand complex is chosen such that it provides some geometrical preferences resulting in selective binding of anions of a particular shape. Examples of suitable ligands include pyridines, amines and any other nitrogen containing ligands. In one embodiment, a dinuclear zinc complex of (2,6-Bis(bis(2-pyridylmethyl)aminomethyl)-4-methyl-phenol) ligand was employed as the analyte-specific reagent.

Metalochromic dyes are used along with the metal complexes. Some examples of metalochromic dyes that can be used with the metal complexes include catechol dyes, triphenylmethane dyes, thiazine dyes, oxazine dyes, anthracene dyes, azo dyes, phthalocyanine dyes, and any combinations thereof. Some specific examples of metalochromic dyes include, but are not limited to, pyrocatechol violet, Murexide, Arsenazo I, Arsenazo III, Antipyrylazo III, Azo1, Acid Chrome Dark Blue K, BATA (bis-aminopehnoxy tetracetic acid), Chromotropic acid, and XB-I (3-[3-(2,4-dimethylphenylcarbamoyl)-2-hydroxynaphthalen]-1-yl-azo]-4-hydroxybenzene sulfonic acid, sodium salt.

The pH-modifier for the analyte-specific reagent comprising a metal complex and a metalochromic dye is selected such that the pH of the sensor formulation is maintained at pH=7. Examples of suitable pH-modifiers include biological buffers such as Good's buffers or amines. An example of biological buffer which may be used includes, but is not limited to, HEPES (2-[4-(2-hydroxyethyl)-1-piperazinyl]ethanesulfonic acid). Examples of suitable amines include, but are not limited to, cycloamines or more specifically cyclohexylamines. The concentration of the pH-modifier is selected such that the color transition of the dye occurs, or a change in absorbance occurs, on contact with the metal complex and the dye.

In one aspect, the self-contained phosphate sensor includes a metal complex, a dye and a sulfonic acid pH-modifier, which are dissolved in a non-aqueous solvent. In another aspect, the self-contained phosphate sensor includes a metal complex, a dye and an amine pH-modifier, which are immobilized in a polymer matrix to form a solid-state device.

The self-contained phosphate sensors described herein may be used in solution or as solid-state devices. For application of phosphate sensor as a solution, a common solvent is chosen for the different constituents of the phosphate sensor. Some examples of such a solvent include, but are not limited to, deionized water (DI water), 1-methoxy-2-propanol (Dowanol), ethanol, acetone, chloroform, toluene, xylene, benzene, isopropyl alcohol, 2-ethoxyethanol, 2-butoxyethanol, methylene chloride, tetrahydrofuran, ethylene glycol diacetate, and perfluoro(2-butyl tetrahydrofuran).

For application of the self-contained phosphate sensor as a solid-state device, the phosphate sensors described above are attached to or immobilized in a polymer matrix. The phosphate sensors are then disposed as a film on a substrate. It is to be appreciated that the polymeric material used to produce the sensor film may affect detection properties such as selectivity, sensitivity, and limit of detection. Thus, suitable materials for the sensor film are selected from polymeric materials capable of providing the desired response time, a desired permeability, desired solubility, degree of transparency and hardness, and other similar characteristics relevant to the material of interest to be analyzed.

Suitable polymers which may be used as polymer supports in accordance with the present disclosure include hydrogels. As defined herein, a “hydrogel” is a three dimensional network of hydrophilic polymers which have been tied together to form water-swellable but water insoluble structures. The term hydrogel is to be applied to hydrophilic polymers in a dry state (xerogel) as well as in a wet state as described in U.S. Pat. No. 5,744,794.

According to one embodiment, a method for synthesizing hydrogels includes synthesis via radiation or free radical cross-linking of hydrophilic materials, examples including, but not limited to, poly(hydroxyethylmethacrylates), poly(acrylic acids), poly(methacrylic acids), poly(glyceryl methacrylate), poly(vinyl alcohols), poly(ethylene oxides), poly(acrylamides), poly(N-acrylamides), poly(N,N-dimethylaminopropyl-N′-acrylamide), poly(ethylene imines), sodium/potassium poly(acrylates), polysaccharides, e.g. xanthates, alginates, guar gum, agarose etc., poly(vinyl pyrrolidone), cellulose based derivatives, and copolymers thereof.

According to another embodiment, the method for synthesizing hydrogels includes synthesis via chemical cross-linking of hydrophilic polymers and monomers with appropriate polyfunctional monomers, examples including, but not limited to, poly(hydroxyethylmethacrylate) cross-linked with suitable agents such as N,N′-methylenebisacrylamide, polyethylene glycol diacrylate, triethylene glycol diacrylate, tetraethylene glycol dimethacrylate, tripropylene glycol diacrylate, pentaerythritol tetraacrylate, di-trimethylolpropane tetraacrylate, dipentaerythritol pentaacrylate, trimethylolpropane triacrylate, pentaerythritol triacrylate, propoxylated glyceryl triacrylate, ethoxylated pentaerythritol tetraacrylate, ethoxylated trimethylolpropane triacrylate, hexanediol diacrylate, hexanediol dimethacrylate and other di- and tri-acrylates and methacrylates; the copolymerisation of hydroxyethylmethacrylate monomer with dimethacrylate ester crosslinking agents; poly(ethylene oxide) based polyurethanes prepared through the reaction of hydroxyl-terminated poly(ethylene glycols) with polyisocyanates or by the reaction with diisocyanates in the presence of polyfunctional monomers such as triols; cellulose derivates cross-linked with dialdehydes, diepoxides and polybasic acids; and copolymers of two or more of foregoing polymers.

According to another embodiment, the method for synthesizing hydrogels includes synthesis via incorporation of hydrophilic monomers and polymers into block and graft copolymers, examples including, but not limited to, block and graft copolymers of poly(ethylene oxide) with suitable polymers such as poly(ethyleneglycol) (PEG), acrylic acid (AA), poly(vinyl pyrrolidone), poly(vinyl acetate), poly(vinyl alcohol), N,N-dimethylaminoethyl methacrylate, poly(acrylamide-co-methyl methacrylate), poly(N-isopropylacrylamide), poly(hydroxypropyl methacrylate-co-N,N-dimethylaminoethyl methacrylate); poly(vinyl pyrrolidone)-co-polystyrene copolymers; poly(vinyl pyrrolidone)-co-vinyl alcohol copolymers; polyurethanes; polyurethaneureas; polyurethaneureas based on poly(ethylene oxide); polyurethaneureas and poly(acrylonitrile)-co-poly(acrylic acid) copolymers; and a variety of derivatives of poly(acrylonitriles), poly(vinyl alcohols) poly(acrylic acids), two or more of foregoing polymers. Molecular complex formation may also occur between hydrophilic polymers and other polymers, examples being poly(ethylene oxides) hydrogel complexes with poly(acrylic acids) and poly(methacrylic acids). According to another embodiment, the method includes synthesis via entanglement cross-linking of high molecular weight hydrophilic polymers, examples including, but not limited to, hydrogels based on high molecular weight poly(ethylene oxides) admixed with polyfunctional acrylic or vinyl monomers.

Copolymers or co-polycondensates of monomeric constituents of the above-mentioned polymers, and blends of the foregoing polymers, may also be utilized. Examples of applications of these materials are described in Michie, et al., “Distributed pH and water detection using fiber-optic sensors and hydrogels,” J. Lightwave Technol. 1995, 13, 1415-1420; Bownass, et al., “Serially multiplexed point sensor for the detection of high humidity in passive optical networks,” Opt. Lett. 1997, 22, 346-348, and U.S. Pat. No. 5,744,794.

The hydrogel making up the polymer matrix is dissolved in a suitable solvent including, but not limited to, 1-methoxy-2-propanol, ethanol, acetone, chloroform, toluene, xylene, benzene, isopropyl alcohol, 2-ethoxyethanol, 2-butoxyethanol, methylene chloride, tetrahydrofuran, ethylene glycol diacetate, and perfluoro(2-butyl tetrahydrofuran). In one aspect, the concentration of the solvent in the solution containing the polymer is in the range from about 70 weight percent to about 90 weight percent. In another aspect, a hydrogel that is used is poly(2-hydroxyethylmethacrylate) (pHEMA) dissolved in a solvent including 1-methoxy-2-propanol.

The polymer matrix of the sensor film is permeable to selected analytes. The sensor film may be selectively permeable to analytes on the basis of size, i.e., molecular weight; hydrophobic/hydrophilic properties; phase, i.e., whether the analyte is a liquid, gas or solid; solubility; ion charge; or, the ability to inhibit diffusion of colloidal or particulate material. In one aspect, additives such as polyethylene glycols, polypropylene glycols, polyoxyethylene alkyl ethers, polyvinyl alcohols, or any combinations thereof may be added to the self-contained phosphate sensors. These additives may aid in enhancing the permeability of the polymer matrix to the analyte species (phosphate in this case) by plasticizing the polymer matrix.

The sensor film described herein may be self-standing or further disposed on a substrate such as glass, plastic, paper or metal. The sensor film may be applied or disposed on the substrate using any techniques known to those skilled in the art, for example, painting, spraying, spin-coating, dipping, screen-printing and the like. In one aspect, the polymer matrix is dissolved in a common solvent for the analyte-specific reagent and the pH-modifier and then dip-coated onto a clear plastic surface to form a thin layer which is then allowed to dry over a period of several hours in the dark. Alternatively, the analyte-specific reagent may be applied directly to a pre-formed polymer film.

The concentration of the solution used to coat the surface of the substrate is kept low, for example, in the range from about 20 weight percent solids to about 30 weight percent solids, so as to not adversely affect the thickness of the film and its optical properties. In one aspect, the thickness of the film is the range from about 1 micron to about 60 microns, in another aspect, the thickness of the film is in the range from about 2 microns to about 40 microns, in another embodiment, the thickness of the film is in the range from about 5 microns to about 20 microns.

In one aspect, the analyte-specific reagent is attached to or incorporated into a sensor film, which is then disposed on an optical media disc such as a CD or a DVD.

In another aspect, the analyte-specific reagent on the sensor film forms sensor spots when applied to the optical storage media substrate. As used herein, “sensor spots” and “sensor regions” are used interchangeably to describe sensor materials placed on the surface, or in an indentation placed in the surface but not penetrating the region containing the digital information, of an optical storage media at predetermined spatial locations for sensing using an optical storage media drive. Depending on the application, the sensor spots are responsive to physical, chemical, biochemical, and other changes in the environment. In some aspects, the sensor film applied to the optical storage media may be subjected to treatment to form these sensor spots. Methods for such application are known to those skilled in the art and may include physical masking systems and both negative and positive photoresist applications. Alternatively, once the optical storage media has been coated with a polymer film, the analyte specific reagent and pH-modifier may be applied as sensor spots to the optical storage media article.

The phosphate sensor is then used to qualitatively and quantitatively analyze the presence of phosphate in an aqueous test sample. In one aspect, a method of determining phosphate in a test sample includes contacting a test sample with the self-contained phosphate-sensor described herein, measuring a change in an optical property of the self-contained phosphate sensor produced by contacting the test sample with the self-contained phosphate-sensor, and converting the change in optical property to the phosphate concentration.

The self-contained phosphate sensor may include an analyte-specific reagent and a pH-modifier. The analyte-specific reagent may be a molybdenum salt and a dye, or a metal complex and a dye. The pH-modifier selected depends upon the nature of the analyte-specific reagent. The self-contained phosphate sensor may be used as a solution or as a solid-state device. In one aspect, the self-contained phosphate sensor includes a molybdenum salt, a dye and a sulfonic acid pH-modifier, which are dissolved in a common solvent or immobilized in polymer matrix and used as a solid-state device. In another aspect, the self-contained phosphate sensor includes a metal complex, a dye and a sulfonic acid pH-modifier, which are dissolved in a non-aqueous solvent. In a further aspect, the self-contained phosphate sensor includes a metal complex, a dye and an amine pH-modifier, which are immobilized in a polymer matrix to form a solid-state device.

Contacting of the phosphate sensor with the test sample may be carried out by any suitable mechanism or technique depending upon whether the sensor is in solution or in solid-state. Some examples by which contacting may occur include, but are not limited to, mixing a solution of the sensor with a test sample solution, by dipping a strip of the sensor in a test-sample solution, by spotting a sensor film with a test sample solution, by flowing a test sample through a testing device having a phosphate sensor, and the like.

After contacting, a change in the optical property of the phosphate sensor is optically measured. The change in the optical property may be simply qualitative such as a change in color of the phosphate sensor. Alternatively, the change may be quantitative, for example, change in elastic or inelastic scattering, absorption, luminescence intensity, luminescence lifetime or polarization state. By way of example, when a phosphate sensor having ammonium molybdate, a thiazine dye such as Azure C, and para-toluenesulfonic acid is contacted with a phosphate sample, the color of the sensor changes from violet to blue and a change in the absorption peak at 650 nm occurs. By measuring the change (increase or decrease) in the absorption peak, the concentration of phosphate can be determined.

In one aspect, measurements of optical response can be performed using an optical system that includes a white light source (such as a Tungsten lamp available from Ocean Optics, Inc. of Dunedin, Fla.) and a portable spectrometer (such as Model ST2000 available from Ocean Optics, Inc. of Dunedin, Fla.). The spectrometer is equipped with a 600-grooves/mm grating blazed at 400 nm and a linear CCD-array detector. Desirably, the spectrometer covers the spectral range from 250 to 800 nm with efficiency greater than 30%. Light from the lamp is focused into one of the arms of a “six-around-one” bifurcated fiber-optic reflection probe (such as Model R400-7-UV/VIS available from Ocean Optics, Inc. of Dunedin, Fla.). The common arm of the probe illuminates the sensor material. The second arm of the probe is coupled to the spectrometer.

After measuring the change in the optical property, the phosphate concentration in the sample can be determined by converting the change in the optical property to the phosphate concentration. This converting may be carried out using a calibration curve. The calibration curve may be generated by measuring changes in an optical property of a phosphate sensor after contacting with test samples of known phosphate concentrations. After the calibration curve is generated, the phosphate concentration in an unknown test sample may be determined by using the calibration curve. In one aspect, the change in absorbance of the phosphate sensor after contacting with a test sample is directly proportional to the phosphate concentration. The self-contained phosphate sensors of embodiments of the invention may be used for sensing phosphate in a broad concentration range. In one aspect, the self-contained phosphate sensor is sensitive to phosphate concentrations in the range from about 1 ppb to about 400 ppm, in another aspect, the self-contained phosphate sensor is sensitive to phosphate concentrations in the range from about 100 ppb to about 100 ppm, and in a further aspect, the self-contained phosphate sensor is sensitive to phosphate concentrations in the range from about 1 ppm to about 50 ppm.

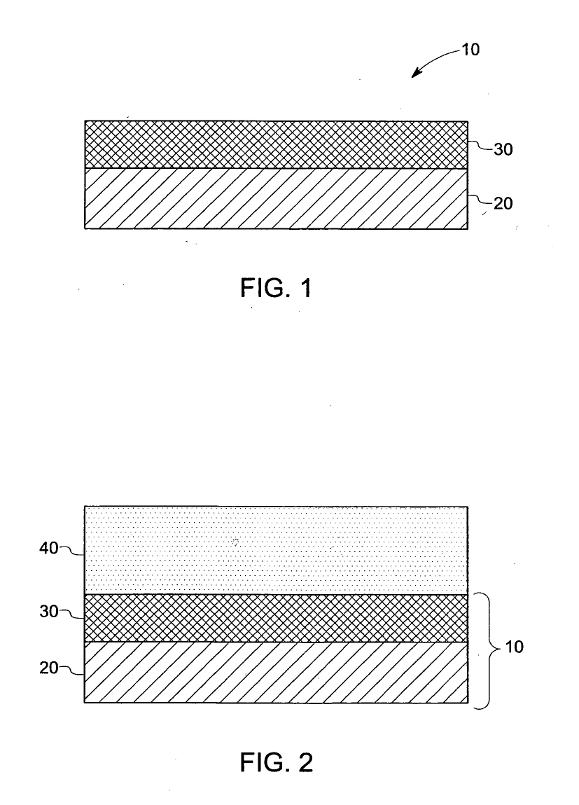

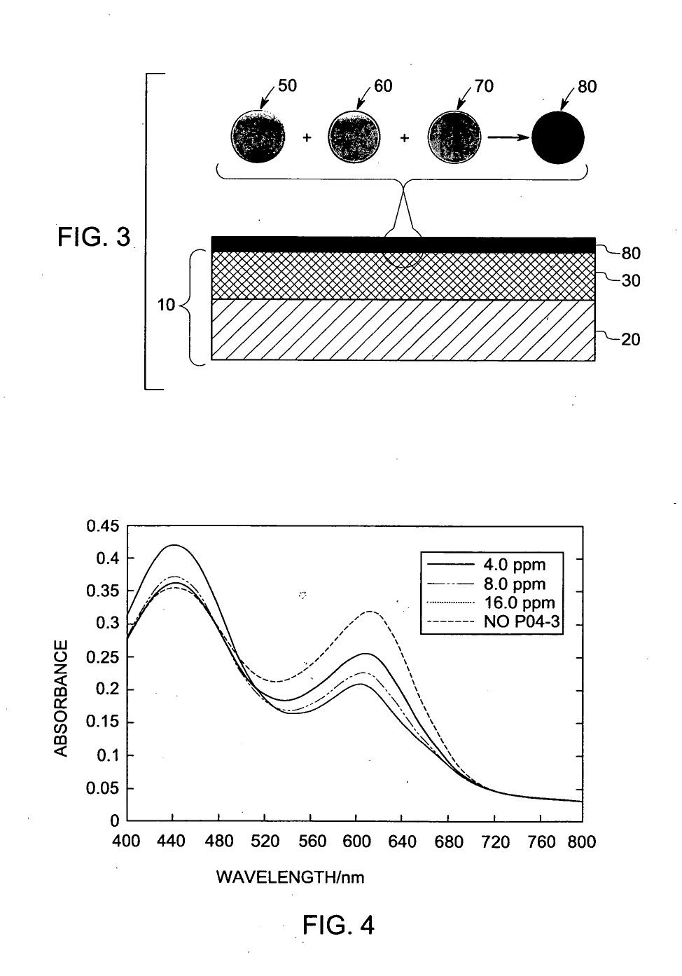

A method of determining phosphate concentrations by using the self-contained phosphate sensor may be further described by referring to the accompanying figures. FIG. 1 is a cross-section of a self-contained phosphate sensor 10 disposed as a film 30 on a substrate 20. The film 30 includes an analyte-specific reagent 50 and a pH-modifier 60 (FIG. 3). The analyte-specific reagent 50 includes a molybdenum salt or metal complex and a dye.

FIG. 2 is a cross-section of the self-contained phosphate sensor 10 in contact with a test sample 40. A method for contacting the sensor 10 with the test sample 40 may occur by any conventional means known to those skilled in the art and whole or part of the sensor 10 may be in contact with the test sample 40.

FIG. 3 is a cross-section of the self-contained phosphate sensor 10 after contacting with the test sample 40 resulting in a change in the optical property of the phosphate sensor 80. Further, FIG. 3 depicts an enlarged portion of the change in optical property brought about by contacting the analyte-specific reagent 50 and pH-modifier 60 with a phosphate 70.

Applications of the self-contained phosphate sensors 10 may include, but are not limited to, analysis of substances in the water treatment industry, in environmental monitoring, in clinic diagnosis, and in other industrial places such as mining and metallurgical processes.

The following examples are included to provide additional guidance to those skilled in the art. These examples are not intended to limit the invention in any manner.

### EXAMPLES

In the following examples the reaction products were analyzed using ¹H NMR Spectroscopy, gas chromatography mass spectrometry (GC/MS), and fast atom bombardment spectrometry (FAB). The sensor device response was measured using an OceanOptrics spectrophotometer equipped with a fiber-optic probe. The probe was oriented at an angle in the range from about 45 degrees to about 90 degrees with respect to the device.

### Example 1

### Synthesis of h-BPMP (2,6-Bis(bis(2-pyridylmethyl)aminomethyl)-4-methyl-phenol)

Synthesis of h-BPMP was conducted according to the Scheme 1. The 2,6-bis(hydroxymethyl)-4-methylphenol (A in Scheme 1) was chlorinated using thionyl chloride in dichloromethane ion 85% yield. The product 2,6-bis(chloromethyl)-4-methylphenol (B in Scheme 1) was exposed to the bispyridine amine to produce the ligand (C in Scheme 1) in 70% yield.

Synthesis of 2,6-bis(chloromethyl)-4-methylphenol: A suspension of the 2,6-bis(hydroxymethyl)-4-methylphenol in 25 mL dichloromethane (DCM) was added to a solution of thionyl chloride in 50 mL DCM. After the addition the mixture was stirred for 10 min. Rapidly a reaction took place dissolving all solids. The amber solution was stirred for 48 hours. The reaction was poured into 100 g ice and the water layer neutralized to pH=7 with NaOH. The organic materials were separated and the aqueous layer extracted with 3×50 mL DCM. The combined organic layers were dried with MS, filtered and evaporated to dryness. This gave 5.2 g (85%) of material B, an amber oil. ¹H NMR indicated product formation of about 90%. GCMS showed the correct molecular ion peak (M+) at 205 m/z. The crude product of the above reaction was used as is for the next step. The unstable product was used within the next 24 hours.

Synthesis of h-BPMP: The 2,6-bis(chloromethyl)-4-methylphenol was dissolved in 15 mL THF and treated under N₂ with a solution of the bis(2-pyridine) amine and the triethylamine in 5 mL THF. Addition was performed at 0° C. for 1 hour. The final suspension was stirred for 48 hours, filtered and concentrated under reduced pressure. The residue was treated with water 20 mL and extracted with DCM (3×30 mL). The organic materials were dry filtered and evaporated. The residue was chromatographed in SiO₂ eluting with acetone. This gave 1.71 (70%) g of material C as an amber solid. FAB: showed the correct molecular ion peak (M+) at 531 m/z. ¹H NMR agreed to the correct product.

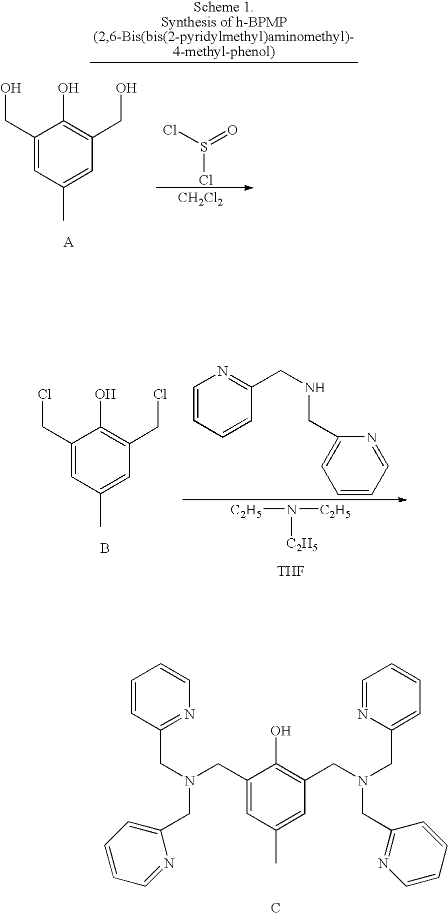

In the following examples, preparation and testing of self-contained phosphate sensors as described in some embodiments will be further illustrated. Scheme 2 illustrates the mechanism of sensing phosphate in an aqueous test sample as described in examples 2 and 3. Scheme 3 illustrates the mechanism of testing phosphate in an aqueous test sample as described in examples 4 to 14.

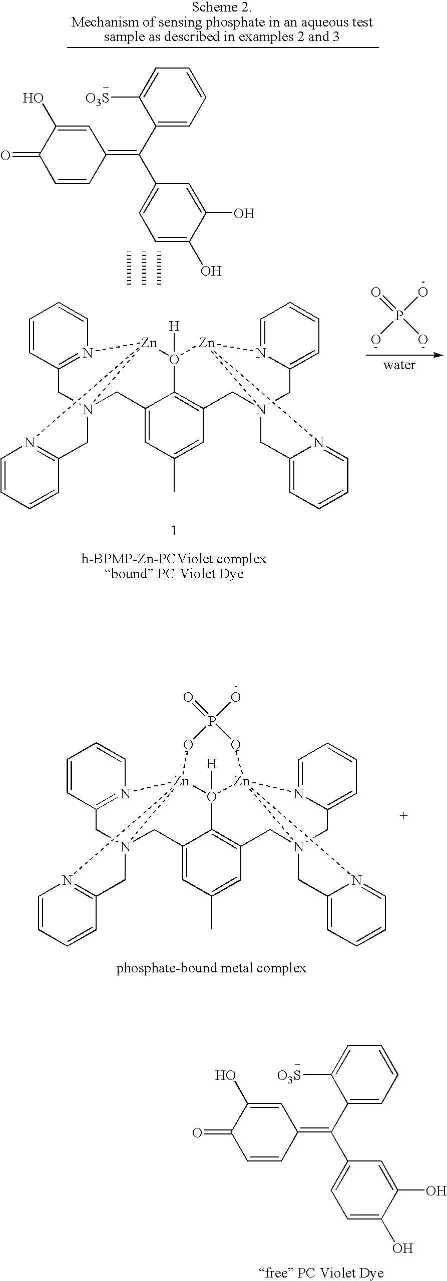

### Example 2

### Preparation and Testing of Sensor Comprising h-PBMP-Zn-PCViolet Complex in Dowanol

Three base solutions were prepared in 100 mL Dowanol: A) ZnBr (FW 145.3), 7.7 mg, 0.053 mmol; B) h-BPMP (FW=530), 28 mg, 0.053 mmol; and C) PCViolet (FW 408.4), 21.5 mg, 0.053 mmol. To an aliquot of 1.0 mL of A was added 1.0 mL of B followed by 1.0 mL of C. To this mixture was added pH=7 solution of 2-[4-(2-hydroxyethyl)-1-piperazinyl]ethanesulfonic acid (HEPES) in Dowanol obtaining a greenish-blue colored solution. A 1.0 mL aliquot solution was diluted with 2 mL Dowanol and exposed to the aqueous PO₄⁻³ solution at pH=6.9 using DI water pH=6.9 as standard with 3 min exposure. UV-Vis spectra were recorded between 400-900 nm.

FIG. 4 shows a typical set of spectra at different phosphate concentrations for the described device.

### Example 3

### Preparation and Testing of Sensor Comprising h-PBMP-Zn-PCViolet Complex in Polymer Matrix

Three base solutions were prepared in 100 mL Dowanol: A) ZnBr (FW 145.3), 7.7 mg, 0.053 mmol; B) h-BPMP (FW=530), 28 mg, 0.053 mmol; and C) PCViolet (FW 408.4), 21.5 mg, 0.053 mmol. To an aliquot of 0.6 mL of A was added 0.6 mL of B followed by 0.6 mL of C. To this mixture was added 1.8 mL of 20% pMMA/pHEMA (1:3) in Dowanol and 3% by weight of dicyclohexylamine obtaining a greenish-blue colored solution. A 5×10 cm polycarbonate sheet (0.5 mm thickness) was coated (using two 3M Scotch Magic tapes film thickness or ˜12 microns) with the above solution. The above coated sheet was air-dried for 2 h and exposed to the aqueous PO₄⁻³ solution at pH=6.9 using DI water pH=6.9 as standard with 3 to 5 min exposure. Film reading was done using an Ocean Optics spectrophotometer between 400-900 in a 45 or 90 degree angle using polycarbonate over white paper as background.

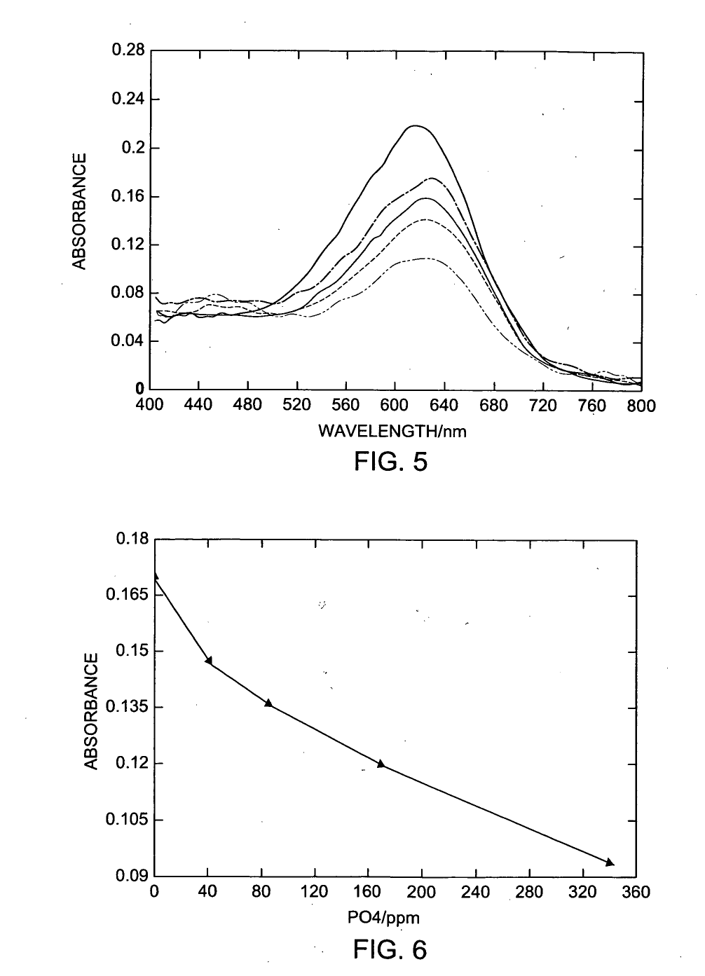

FIG. 5 shows a typical set of spectra at different phosphate concentrations for the described device. FIG. 6 shows the calibration curve for the described device obtained by plotting absorbances at 650 nm as a function of phosphate concentration.

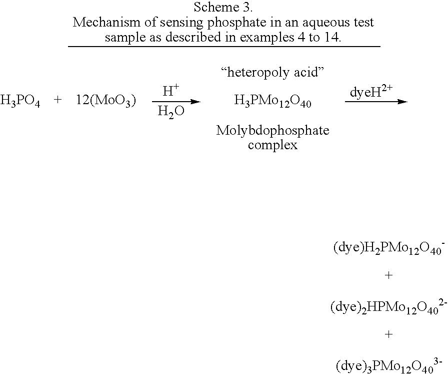

### Example 4

### Preparation and Testing of Sensor Comprising Azure C and Molybdate Salt in Water: Violet-to-Blue Reaction

p-Toluenesulfonic acid (TsOH), ammonium molybdate and Azure C were dissolved in DI (deionized) water at required concentrations. A 2 mL solution of 0.05 M TsOH was mixed with 0.25 mL of 0.068 M ammonium molybdate solution followed by 0.1 mL of Azure C solution (10 mg in 10 mL water, Aldrich 242187) in a 1-cm disposable cuvette. About 0.5 mL of aqueous samples of phosphate at different concentrations was added to the above solution. UV-Vis spectra were recorded between 400-900 nm.

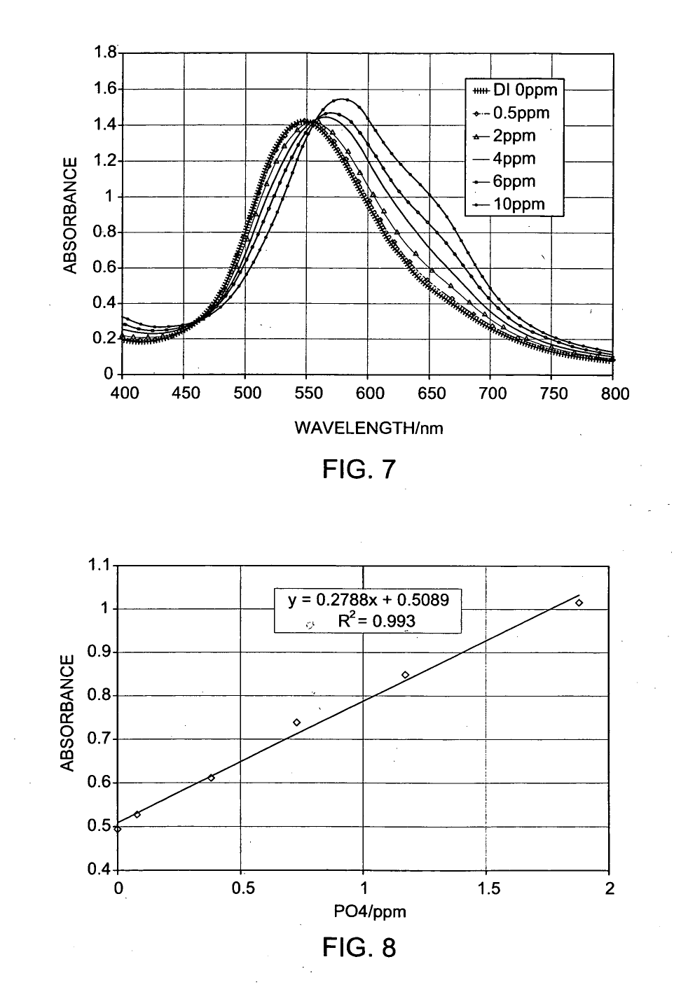

FIG. 7 shows a typical set of spectra at different phosphate concentrations for the described device. FIG. 8 shows the calibration curve for the described device obtained by plotting absorbances at 650 nm as a function of phosphate concentration.

### Example 5

### Preparation and Testing of Sensor Comprising Azure B and Molybdate Salt in Water: Violet-to-Blue Reaction.

p-Toluenesulfonic acid (TsOH), ammonium molybdate and Azure B were dissolved in DI (deionized) water at required concentrations. A 2 mL solution of 0.05 M TsOH was mixed with 0.25 mL of 0.068 M ammonium molybdate solution followed by 0.1 mL of Azure B solution (4 mg in 10 mL water, Aldrich 227935) in a 1-cm disposable cuvette. About 0.5 mL of aqueous samples of phosphate at different concentrations were added to the above solution. UV-Vis spectra were recorded between 400-900 nm.

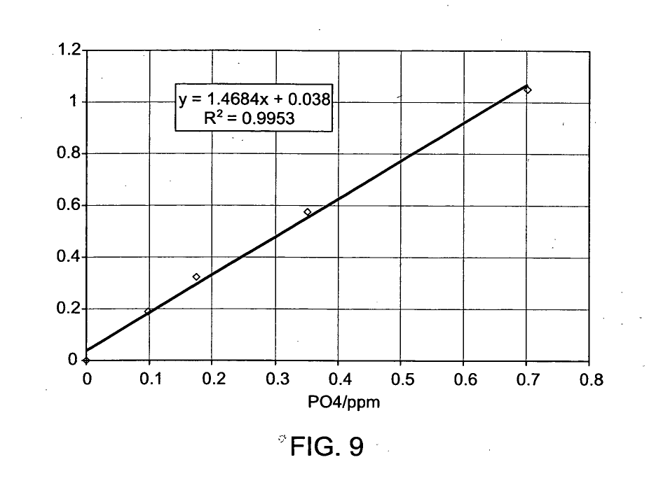

FIG. 9 shows a typical set of spectra at different phosphate concentrations for the described device.

### Example 6

### Preparation and Testing of Sensor Comprising Azure B and Molybdate Salt in Water: Blue-to-Violet Reaction.

p-Toluenesulfonic acid (TsOH), ammonium molybdate and Azure B were dissolved in DI (deionized) water at required concentrations. A 2 mL solution of 0.5 M TsOH was mixed with 0.25 mL of 0.068 M ammonium molybdate solution followed by 0.1 mL of Azure B solution (4 mg in 10 mL water, Aldrich 227935) in a 1-cm disposable cuvette. About 0.5 mL of aqueous samples of phosphate at different concentrations were added to the above solution. UV-Vis spectra were recorded between 400-900 nm.

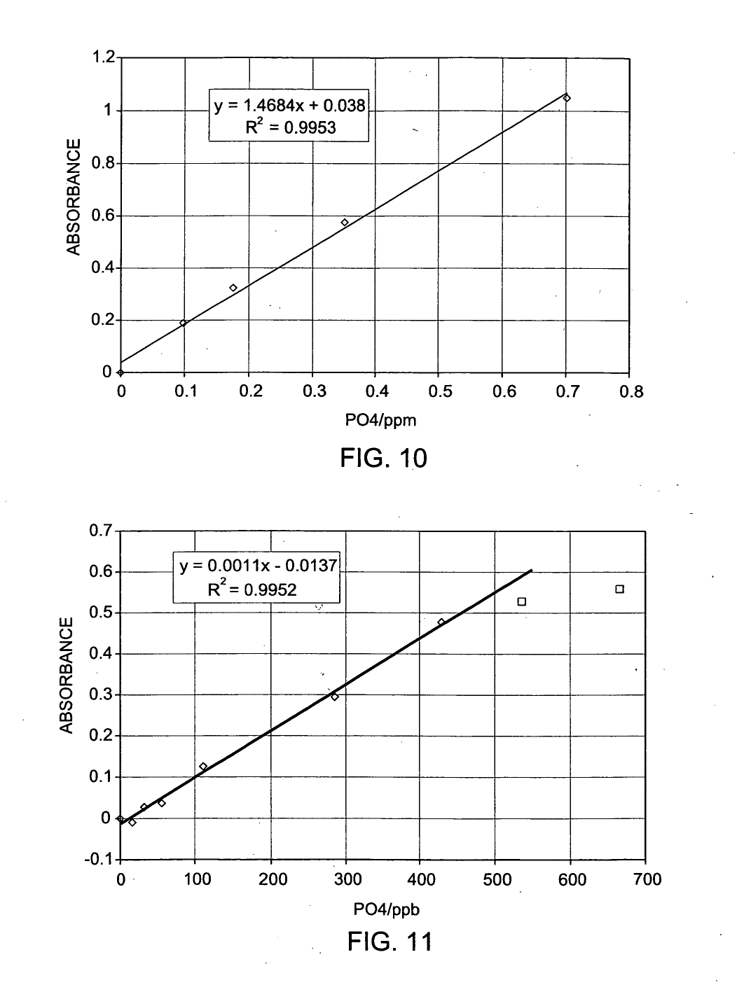

FIG. 10 shows the calibration curve for the described device obtained by plotting absorbances at 650 nm as a function of phosphate concentration.

### Example 7

### Preparation and Testing of Sensor Comprising Brilliant Cresyl Blue and Molybdate Salt in Water: Blue-to-Violet Reaction

p-Toluenesulfonic acid (TsOH) was dissolved in DI (deionized) water at required concentrations. A 0.1 mL of 0.0068 M ammonium molybdate solution (in 0.154 M TsOH) was mixed with 0.1 mL of 0.178 mM BCB solution (Aldrich 858374) (in 0.166 M TsOH) in a 1-cm disposable cuvette. About 2 mL of aqueous samples of phosphate at different concentrations were added to the above solution. UV-Vis spectra were recorded between 400-900 nm.

FIG. 11 shows the calibration curve for the described device obtained by plotting absorbances at 622 nm as a function of phosphate concentration.

### Example 8

### Preparation and Testing of Sensor Comprising Azure B and Molybdate Salt in Water: Low Concentration Range Calibration

A 20 ml orthophosphate sample (containing 0 to 800 ppb phosphate as PO₄) was placed in a 2-inch cuvette, whose optical path length was 2.43 cm. Then 0.914 g 0.174 mM of Azure B (in 1.54 mol/kg TsOH) and 1.063 g 0.068 mol/kg of ammonium molybdate (in 1.54 mol/kg TsOH) were added into the cuvette. The absorbance at 650 nm with Hach DR2000 was measured three minutes after the reagents are added into the sample.

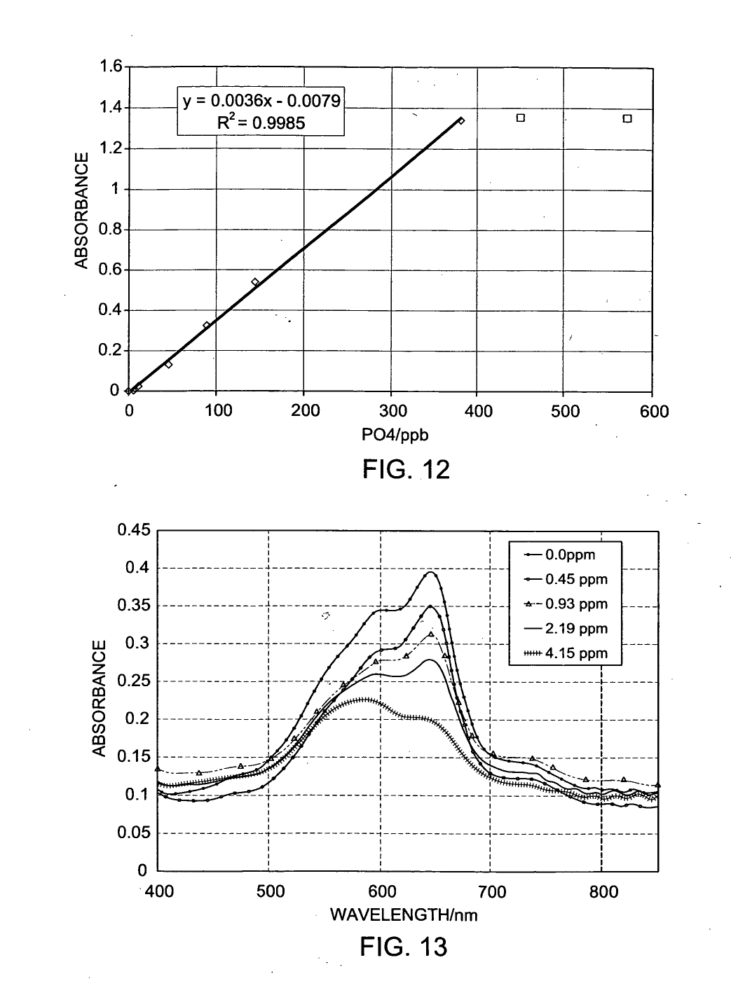

FIG. 12 shows the calibration curve for the described device obtained by plotting absorbances at 650 nm as a function of phosphate concentration. The molar extinction coefficient for this method was calculated from the slope of the calibration curve to be 140700 L/(mol cm).

### Example 9

### Determination of Phosphate Concentration in a Tap Water Sample with a Sensor Comprising Molybdate Salt and Azure B

p-Toluenesulfonic acid (TsOH), ammonium molybdate and Azure B were dissolved in DI (deionized) water at required concentrations. A 2 mL solution of 0.2 M TsOH was mixed with 0.25 mL of 0.034 M ammonium molybdate solution followed by 0.1 mL of Azure B solution (4 mg in 10 mL water) in a 1-cm disposable cuvette. About 0.5 mL of tap water sample was added to the above solution. UV-Vis spectrum was recorded between 400-900 nm. A calibration curve was obtained with phosphate standard solutions prepared from an ACS grade trisodium phosphate, which were standardized with Hach PhosVer 3 method: [PO4]/ppm=−2.867·A₆₅₀+5.915. The unknown phosphate concentration in the sample was determined to be 1.45 ppm. This value agreed with 1.47 ppm analyzed by ICP and 1.25 ppm by the Hach method. A survey of other contaminants in this water sample was conducted using an ICP emission spectrometer. The major species were: Ca, 62 ppm; Mg, 16 ppm; Si, 5.2 ppm.

### Example 10

### Preparation and Testing of Sensor Comprising Azure B and Molybdate Salt in a Polymer Matrix

Ammonium molybdate and Azure B were dissolved in deionized water or 1-methoxy-2-propanol (Dowanol PM) at required concentrations. To a 0.15 mL solution of 9.12 mM Azure B was added 0.05 mL of 0.68 M ammonium molybdate, and 0.33 g TsOH in 5 g solution of 20% pHEMA in Dowanol. The sensor device was prepared by flow coating a polycarbonate sheet with a thin layer of the chemical mixture and allowed to dry over a period of several hours in the dark. The final film thickness was between 5 and 20 microns. The sensor device was exposed to about 50 μL of aqueous samples of phosphate at various concentrations by spotting onto the film surface. The liquid sample was removed 2 minutes after spotting the sample and dried with a constant airflow. The sensor device was then measured for phosphate response. The device was placed in a dark room on a flat surface. The sensor device response was measured using a spectrophotometer equipped with a fiber-optic probe. The probe was oriented at an angle of 90° with respect to the device. Polycarbonate over white paper was used as background.

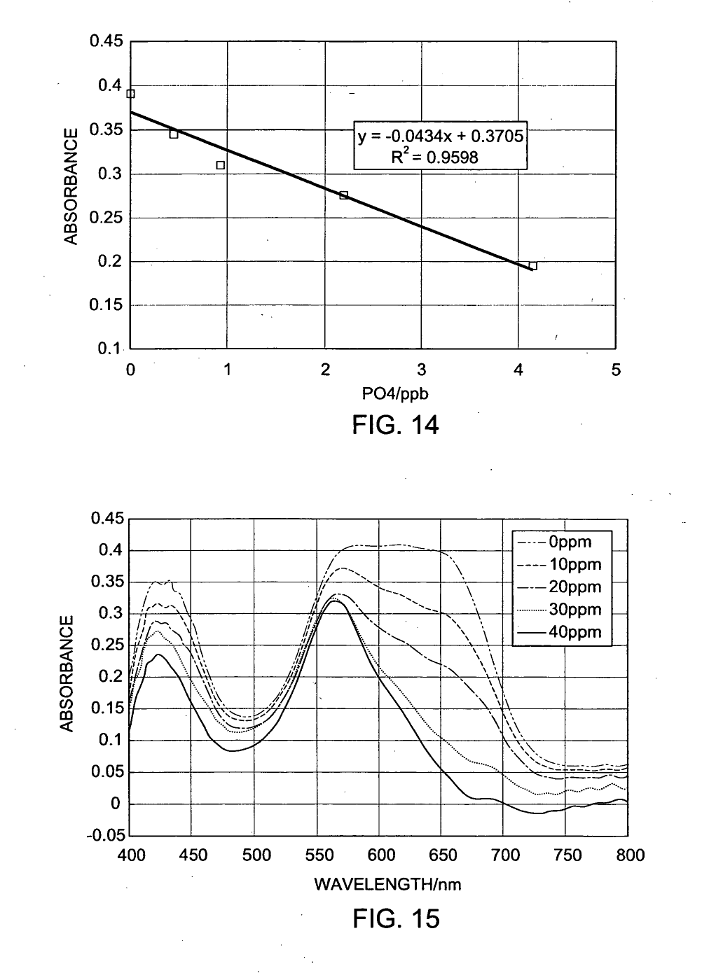

FIG. 13 shows a typical set of spectra at different phosphate concentrations for the described device. FIG. 14 shows the calibration curve for the described device obtained by plotting absorbances at 650 nm as a function of phosphate concentration.

### Example 11

### Preparation and Testing of Sensor Comprising Malachite Green and Molybdate Salt in a Polymer Matrix

Malachite Green (8 mg), TsOH (105 mg) and 0.050 mL of 0.51 M ammonium molybdate solution were mixed in 2.5 g 20% pHEMA solution. The sensor device was prepared by flow coating a polycarbonate sheet with a thin layer of the chemical mixture and allowed to dry over a period of several hours in the dark. The final film thickness was between 5 and 20 microns. The sensor device was exposed to about 20 μL of aqueous samples of phosphate at various concentrations by spotting onto the film surface. The liquid sample was removed 2 minutes after spotting the sample and dried with a constant airflow. The sensor device was then measured for phosphate response. The device was placed in a dark room on a flat surface. The sensor device response was measured using a spectrophotometer equipped with a fiber-optic probe. The probe was oriented at an angle of 90° with respect to the device. Polycarbonate over white paper was used as background.

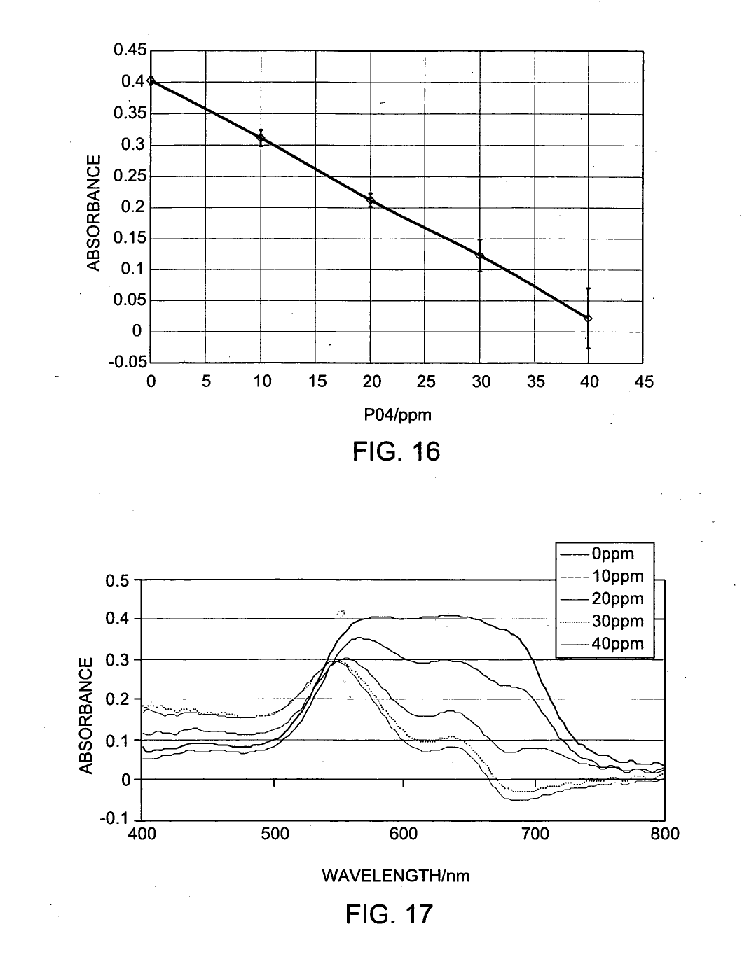

FIG. 15 shows a typical set of spectra at different phosphate concentrations for the described device. FIG. 16 shows the calibration curve for the described device obtained by plotting absorbances at 650 nm as a function of phosphate concentration.

### Example 12

### Preparation and Testing of Sensor Comprising Basic Blue and Molybdate Salt in a Polymer Matrix

Basic Blue 3 (5 mg), TsOH (105 mg) and 0.025 mL of 0.51 M ammonium molybdate solution were mixed in 2.5 g 20% pHEMA solution. The sensor device was prepared by flow coating a polycarbonate sheet with a thin layer of the chemical mixture and allowed to dry over a period of several hours in the dark. The final film thickness was between 5 and 20 microns. The sensor device was exposed to about 20 μL of aqueous samples of phosphate at various concentrations by spotting onto the film surface. The liquid sample was removed 2 minutes after spotting the sample and dried with a constant airflow. The sensor device was then measured for phosphate response. The device was placed in a dark room on a flat surface. The sensor device response was measured using a spectrophotometer equipped with a fiber-optic probe. The probe was oriented at an angle of 90° with respect to the device. Polycarbonate over white paper was used as background.

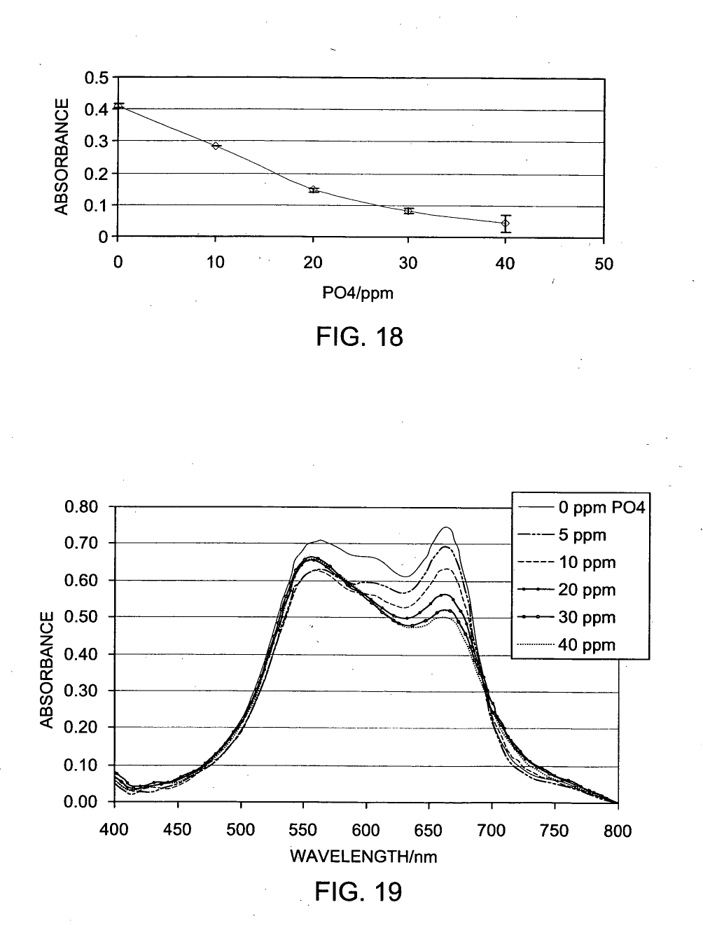

FIG. 17 shows a typical set of spectra at different phosphate concentrations for the described device. FIG. 18 shows the calibration curve for the described device obtained by plotting absorbances at 650 nm as a function of phosphate concentration.

### Example 13

### Preparation and Testing of Sensor Comprising Methylene Blue and Molybdate Salt in a Polymer Matrix

To a 2.5 g solution of 20% pHEMA in a hydroxylether based solvent, was added 2 mg of methylene blue, 5 mg sodium oxalate, 10 μL of a 0.64 M (NH)₆(Mo₇O₂₄).H₂O and 105 mg TsOH. The mixture was stirred at 21° C. in the dark until all solids were dissolved. The device was prepared by coating a clear plastic surface with a thin layer of the chemical mixture and allowed to dry over a period of several hours in the dark. The final film thickness was between 5 and 20 microns. The device was exposed to about 50 μL of aqueous samples of phosphate at various concentrations. Exposure time was in general 120 seconds. The water sample was then removed and the film dried with a constant airflow. The device was then measured for phosphate response. The device was placed in a dark room on a flat surface. The sensor device response was measured using a spectrophotometer equipped with a fiber-optic probe. The probe was oriented at an angle of 90° with respect to the device.

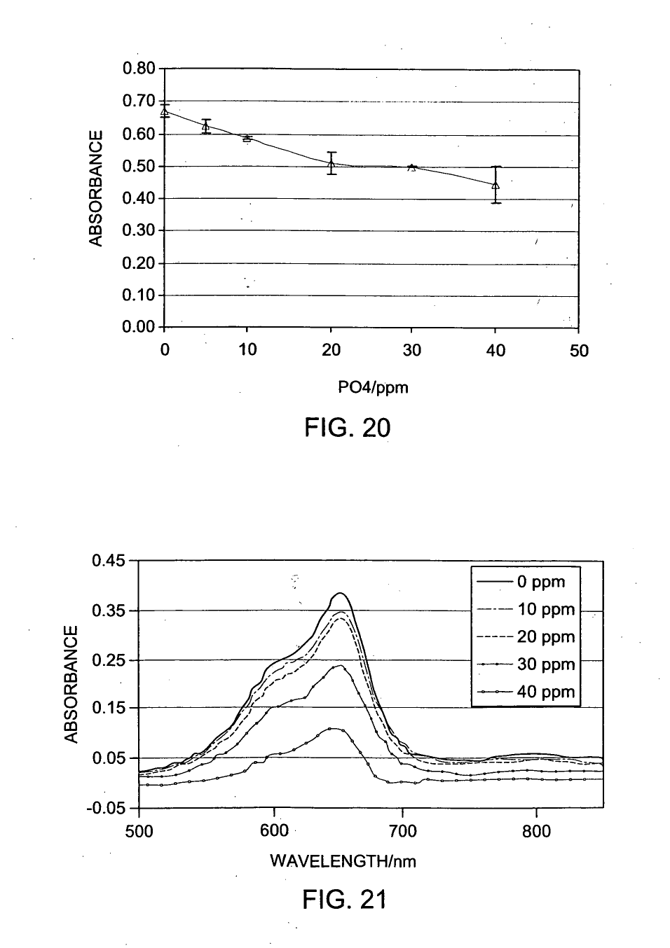

FIG. 19 shows a typical set of spectra at different phosphate concentrations for the described device. FIG. 20 shows the calibration curve for the described device obtained by plotting absorbances at 650 nm as a function of phosphate concentration.

### Example 14

### Preparation and Testing of Sensor Comprising Basic Blue and Molybdate Salt in a Plasticized Polymer Matrix

Basic Blue 3 (9 mg), TsOH (672 mg), polyethylene glycol 400 (302 mg), ammonium molybdate (0.076 mL of 0.0.68 M aqueous solution), and sodium oxalate (24 mg) were mixed in 10.0 g 20% pHEMA solution. The sensor device was prepared by screen-printing onto a polycarbonate substrate with a thin layer of the chemical mixture and allowed to dry at 70° C. for 5 minutes. The sensor was then stored in the dark at room temperature and ambient humidity over a period of 11 days. The final film thickness was between 5 and 20 microns. The sensor device was exposed to about 20 μL of aqueous samples of phosphate at various concentrations by spotting onto the film surface. The liquid sample was removed 2 minutes after spotting the sample and dried with a constant airflow. The sensor device was then measured for phosphate response. The device was placed in a dark room on a flat surface. The sensor device response was measured using a spectrophotometer equipped with a fiber-optic probe. The probe was oriented at an angle of 750 with respect to the device, although other angles have been demonstrated with similar results. Polycarbonate was used as background.

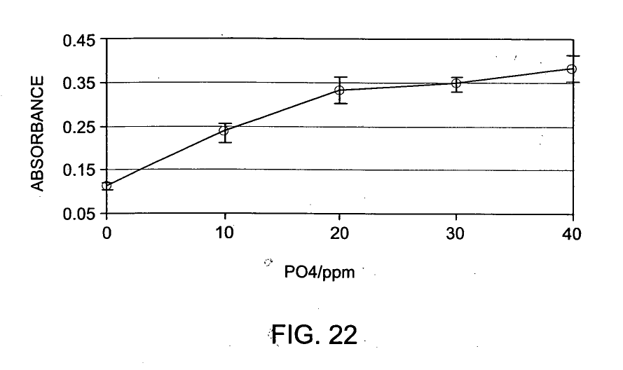

FIG. 21 shows a typical set of spectra at different phosphate concentrations for the described device. FIG. 22 shows the calibration curve for the described device obtained by plotting absorbances at 650 nm as a function of phosphate concentration.

While the invention has been described in detail in connection with only a limited number of aspects and embodiments, it should be readily understood that the invention is not limited to such disclosed aspects and embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A self-contained phosphate sensor comprising:
at least one analyte-specific reagent comprising a molybdate salt and a dye; and
a pH-modifier comprising at least one sulfonic acid.

2. The self-contained phosphate sensor of claim 1, wherein said dye comprises at least one from the group consisting of azo dyes, oxazine dyes, thiazine dyes, triphenylmethane dyes, and any combinations thereof.

3. The self-contained phosphate sensor of claim 1 further comprising at least one additive from the group consisting of polyethylene glycols, polypropylene glycols, polyoxyethylene alkyl ethers, polyvinyl alcohols, and any combinations thereof.

4. The self-contained phosphate sensor of claim 1 further comprising a signal enhancer comprising at least one from the group consisting of oxalic acids, sulfonic acids, oxalates, sulfonates, and any combinations thereof.

5. The self-contained phosphate sensor of claim 4, wherein said signal enhancer and said pH-modifier are formed of the same material.

6. The self-contained phosphate sensor of claim 1, further comprising at least one solvent.

7. The self-contained phosphate sensor of claim 1, further comprising a polymer matrix.

8. The self-contained phosphate sensor of claim 7, wherein said polymer matrix comprises at least one hydrogel from the group consisting of poly(hydroxyethylmethacrylates), poly(methylmethacrylates), poly(acrylic acids), poly(methacrylic acids), poly(glyceryl methacrylate), poly(vinyl alcohols), poly(ethylene oxides), poly(acrylamides), poly(N-acrylamides), poly(N,N-dimethylaminopropyl-N′-acrylamide), poly(ethylene imines), sodium/potassium poly(acrylates), polysaccharides, poly(vinyl pyrrolidone), and copolymers thereof.

9. The self-contained phosphate sensor of claim 8 disposed as a film on a substrate.

10. A self-contained phosphate sensor comprising:
at least one analyte-specific reagent comprising a metal complex and a dye;
a pH-modifier comprising at least one sulfonic acid; and
at least one non-aqueous solvent.

11. The self-contained phosphate sensor of claim 10, wherein said metal complex comprises at least one from the group consisting of zinc metal complexes, copper metal complexes, and any combinations thereof.

12. The self-contained phosphate sensor of claim 10, wherein said dye comprises at least one from the group consisting of catechol dyes, triphenylmethane dyes, thiazine dyes, oxazine dyes, anthracene dyes, azo dyes, phthalocyanine dyes, and any combinations thereof.

13. A self-contained phosphate sensor comprising:
at least one analyte-specific reagent comprising a metal complex and a dye;
a pH-modifier comprising at least one amine; and
a polymer matrix.

14. The self-contained phosphate sensor of claim 13, wherein said metal complex comprises at least one from the group consisting of zinc metal complexes, copper metal complexes, and any combinations thereof.

15. The self-contained phosphate sensor of claim 13, wherein said dye comprises at least one from the group consisting of catechol dyes, triphenylmethane dyes, thiazine dyes, oxazine dyes, anthracene dyes, azo dyes, phthalocyanine dyes, and any combinations thereof.

16. The self-contained phosphate sensor of claim 13, wherein said polymer matrix comprises at least one hydrogel from the group consisting of poly(hydroxyethylmethacrylates), poly(methylmethacrylates), poly(acrylic acids), poly(methacrylic acids), poly(glyceryl methacrylate), poly(vinyl alcohols), poly(ethylene oxides), poly(acrylamides), poly(N-acrylamides), poly(N,N-dimethylaminopropyl-N′-acrylamide), poly(ethylene imines), sodium/potassium poly(acrylates), polysaccharides, poly(vinyl pyrrolidone), and copolymers thereof.

17. The self-contained phosphate sensor of claim 13, further comprising a substrate upon which said polymer matrix is disposed.

18. A method for determining phosphate concentration in a sample, said method comprising:
contacting said sample with a self-contained phosphate-sensor comprising at least one analyte-specific reagent comprising a molybdate salt and a dye and a pH-modifier comprising at least one sulfonic acid;
measuring a change in an optical property of said self-contained phosphate sensor produced by contacting said sample with said self-contained phosphate-sensor; and
converting said change in optical property to said phosphate concentration.

19. The method of claim 18, wherein said change in optical property comprises change in elastic scattering, inelastic scattering, absorption, luminescence intensity, luminescence lifetime or polarization state.

20. The method of claim 18, wherein said converting is conducted by using a calibration curve.

21. A method for determining phosphate concentration in a sample, said method comprising:
contacting said sample with a self-contained phosphate-sensor comprising at least one analyte-specific reagent comprising a metal complex and a dye, a pH-modifier comprising at least one sulfonic acid, and at least one non-aqueous solvent;
measuring a change in an optical property of said self-contained phosphate sensor produced by contacting said sample with said self-contained phosphate-sensor; and
converting said change in optical property to said phosphate concentration.

22. The method of claim 21, wherein said change in optical property comprises change in elastic scattering, inelastic scattering, absorption, luminescence intensity, luminescence lifetime or polarization state.

23. The method of claim 21, wherein said converting is conducted by using a calibration curve.

24. A method for determining phosphate concentration in a sample, said method comprising:
contacting said test sample with a self-contained phosphate-sensor comprising at least one analyte-specific reagent comprising a metal complex and a dye, a pH-modifier comprising at least one amine, and at least one polymer matrix;
measuring a change in an optical property of said self-contained phosphate sensor produced by contacting said sample with said self-contained phosphate-sensor; and
converting said change in optical property to said phosphate concentration.

25. The method of claim 24, wherein said change in optical property comprises change in elastic scattering, inelastic scattering, absorption, luminescence intensity, luminescence lifetime or polarization state.

26. The method of claim 24, wherein said converting is conducted by using a calibration curve.
